(19) United States
(12) Patent Application Publication
(10) Pub. No.: US 2009/0128276 A1
(43) Pub. Date: May 21, 2009

(54) LIGHT WEIGHT REWORKABLE INDUCTOR

(76) Inventors: John Horowy, Rockford, IL (US); Debabrata Pal, Hoffman Estates, IL (US); Frank Z. Feng, Loves Park, IL (US); Steven Schwitters, Rockford, IL (US)

Correspondence Address: CARLSON, GASKEY & OLDS, P.C., 400 WEST MAPLE ROAD, SUITE 350, BIRMINGHAM, MI, 48009, US

(21) Appl. No.: 11/942,105

(22) Filed: Nov. 19, 2007

(51) Int. Cl. H01F 27/32; H01F 27/02

(52) U.S. Cl. 336/96

(57) ABSTRACT

An electrical inductor has at least one wire wound core. When the wire wound core is placed within the shell at least one cavity is present. This cavity is filled with a powder to provide the inductor with better thermal and electrical properties.

### BACKGROUND OF THE INVENTION

The present application relates to the construction and configuration of an electrical inductor, where a powder is used to improve the heat dissipation properties of the inductor.

An electrical inductor typically comprises a series of electrical windings wrapped around a core material. The windings generate an electromagnetic field when current is applied. The properties of the inductor cause it to initially resist current as it builds up the electromagnetic field, and then allow current to pass once the electromagnetic field is in place. Inductors also store energy in the electromagnetic field resulting in a temporary continuation of current flow after any external current source is removed. These properties make inductors key elements in many circuit designs, including circuits with extremely high current frequencies. While operating at high current frequencies inductors typically generate high levels of heat and it can therefore become necessary to devise a way to remove the heat to prevent the inductor from being damaged. Inductors additionally can emit a high pitched tonal acoustic noise while operating at high frequencies.

It is known in the art to create electrical inductors with a potting material packed between the wire wound coils and the casing. The potting material provides a two-fold benefit. First the potting material can create a thermal path to draw heat away from the wire wound coil thereby providing more efficient heat dissipation, and second the potting material provides sound damping thereby reducing the high pitched tonal acoustic noise that can arise under certain circumstances.

Known potting materials are typically created by mixing a liquid matrix (such as epoxy) with a solid fill material. Potting material made in this way uses the thermal and electrical conductivity properties of the solid fill material to allow heat to be drawn away from the electrical windings of the inductor, without causing short circuits. The process used to create an inductor using potting material involves first mixing the fill material and the liquid matrix, pouring a first layer of the potting material into the assembled inductor, allowing the first layer to dry, and then applying additional layers as needed using the same process. Conventionally the maximum amount of the fill material does not typically exceed 70% of the overall mixture. Using conventional methods and potting materials, if the concentration of fill material in the potting material is too high then the potting material cannot be poured and the process described above cannot be performed.

Historically this method of assembling an inductor has had several associated drawbacks. A first drawback is that once the potting material application process is started the inductor cannot be reworked. As a result, any error in the potting material application or any defect in the potting material itself will cause the entire inductor to be scrapped. A second drawback is that the fill material is often unevenly distributed throughout the potting material, resulting in embedded air voids. This results in uneven heat dissipation as areas containing more fill material will be more efficient at conducting heat. A third drawback of this method is that the process of applying the potting material is relatively long and complicated, thus increasing costs and the possibility of defects.

### SUMMARY OF THE INVENTION

Disclosed is an electrical inductor using at least one wire wound core. The inductor has at least one cavity adjacent to the wire wound core, and the cavity is at least partially filled by a powder.

These and other features of the present invention can be best understood from the following specification and drawings, the following of which is a brief description.

### BRIEF DESCRIPTION OF THE DRAWINGS

FIG. 1 illustrates an isometric view of one embodiment prior to adding powder.

FIG. 2 illustrates a cut out view of one embodiment.

### DETAILED DESCRIPTION OF THE PREFERRED EMBODIMENT

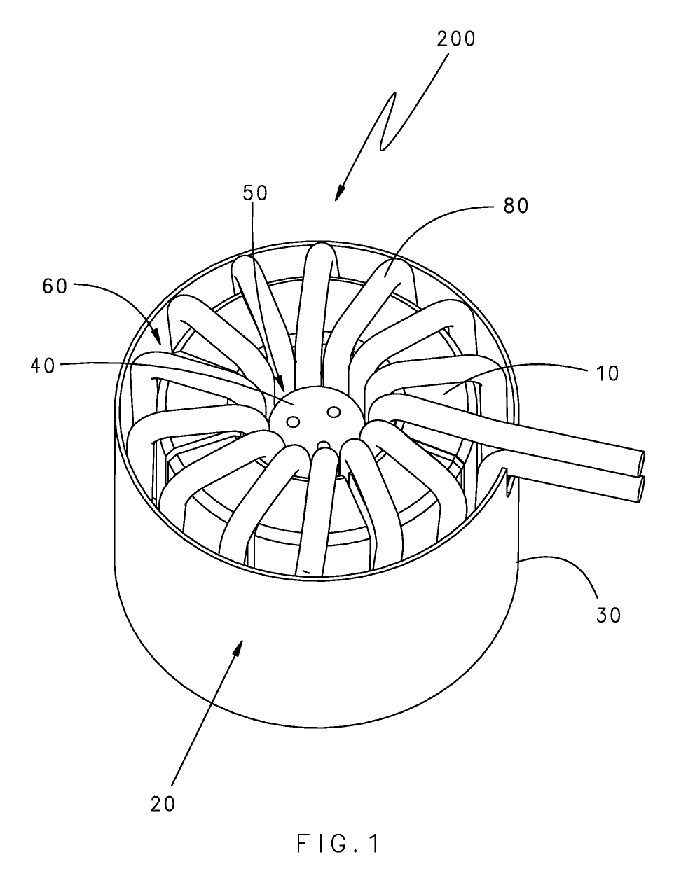

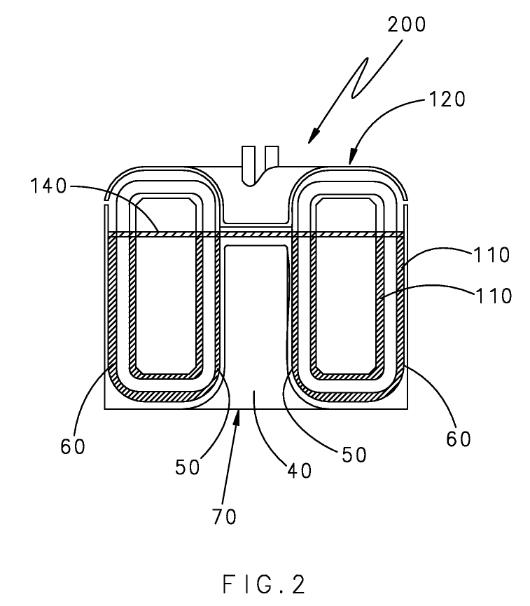

FIG. 1 shows an isometric view of an embodiment of the inductor 200 of the application. In this embodiment a wire wound core 10 is inserted into a shell 20. The shell 20 is constructed out of an outer shell 30 and an inner shell 40. The inner shell 40 and the outer shell 30 are connected at a base 70 (shown in FIG. 2) to form the shell 20 and can have a cap 120 (shown in FIG. 2) placed over the top of the shell 20 to fully encapsulate the wire wound core 10. The shell 20 in the embodiment of FIG. 1 is illustrated containing a single toroidal wire wound core 10, however it is anticipated that the shell 20 could be easily modified by one having ordinary skill to accommodate multiple toroidal wire wound cores 10, or one or more non-toroidal wire wound cores.

As illustrated in FIG. 1, in one embodiment the wire wound core 10 has a cavity 60 between itself, and the outer shell 30. There is an additional cavity 50 between the wire wound core 10 and the inner shell 40. During the assembly process, the cavities 50, 60 are filled with a powder 110 (shown in FIG. 2). Once in place the powder 110 acts to create a thermal path capable of drawing heat away from the wire wound core 10 and the wire 80. The powder 110 can be evenly poured into the cavities 50, 60 and allowed to settle, thereby forming an even distribution of thermal conductivity. If an error occurs during the manufacturing of the inductor 200 it is possible to remove the powder 110 after it has been applied and fix the error. The powder 110 provides a more even distribution than a liquid matrix based potting material because the powder 110 does not require being mixed with any other materials.

FIG. 2 illustrates an internal view of an assembled inductor 200 pursuant to an embodiment of the application. The shell cap 120 is placed over the shell 20 enclosing the inductor 200. As shown, powder 110 partially fills the cavities 50, 60. Sealing the powder 110 in place, is a sealing component 140. In the illustrated embodiment the sealing component 140 could be a resin encapsulant, an epoxy encapsulant or any other seal that would prevent the powder 110 from shifting or spilling. When a resin or epoxy encapsulant is used as the sealing component 140 an additional step of applying a liquid resin or epoxy layer on top of the powder 110 is performed after the powder 110 is in place. It is additionally anticipated that any other method of sealing the powder 110 in place could be used including micro-coating the particles of the powder 110 with a temperature or UV light sensitive adhesive and then submitting the powder 110 to the appropriate stimulus after the powder 110 is in place.

As illustrated in FIG. 2 the powder 110 is placed in the cavities 50, 60. This creates a thermal path that draws the heat away from the wire wound core 10 and wire 80, and allows for efficient cooling of the inductor 200. Additionally the location and composition of the thermal path allows for a significant level of sound damping.

Powder 110 can be any powder that provides adequate thermal conductivity, as well as electrical resistivity. One example of a powder 110 that could meet the thermal and resistive requirements is a Boron Nitride powder. A powder meeting these characteristics enables a thermal path away from the wire wound core 10, while at the same time not enabling an electrical path connecting the windings 80 that could cause the windings 80 to short circuit. It is additionally possible to coat the powder particles with a micro-coating that reacts to heat, UV light, or other stimuli and creates an adhesive bond. This allows the powder to be placed in the inductor, and allows for reworking the inductor until the inductor is ready to be finalized. Then, a stimulus can be applied, bonding the powder particles together and holding the powder 110 in place. Using a micro-coating in this way makes use of a sealing layer above the powder unnecessary, as the adhesive nature of the micro-coating would hold the powder in place. Use of lightweight powder or powder with micro-coating results in a light weight potting compound.

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

What is claimed is:

1. An electrical inductor comprising:
at least one wire wound core;
at least one cavity adjacent to said at least one wire wound core; and
a powder at least partially received within said at least one cavity.

2. The inductor of claim 1 wherein said powder comprises a thermally conductive powder.

3. The inductor of claim 1 wherein said powder comprises an electrically insulating powder.

4. The inductor of claim 1 wherein said powder comprises Boron Nitride.

5. The inductor of claim 1 comprising a sealing component capable of preventing said powder from escaping said at least one cavity.

6. The inductor of claim 5 wherein said sealing component comprises a layer of epoxy.

7. The inductor of claim 5 wherein said sealing component comprises a layer of resin.

8. The inductor of claim 5 wherein said sealing component comprises a powder particle micro-coating.

9. The inductor of claim 1 wherein said powder comprises epoxy coated powder particles.

10. The inductor of claim 1 comprising an outer shell disposed outside said at least one wire wound core.

11. The inductor of claim 10 comprising at least one inner shell disposed inside said at least one wire wound core.

12. The inductor of claim 11 wherein said outer shell and said inner shell are connected at a base.

13. The inductor of claim 12 wherein said at least one cavity is bounded by said outer shell and said at least one wire wound core.

14. The inductor of claim 12 wherein said at least one cavity is bounded by said inner shell and said at least one wire wound core.

15. The inductor of claim 12 wherein said powder, said inner shell, and said outer shell are configured to enable a thermal path for drawing heat away from said at least one wire wound core.

16. The inductor of claim 1 wherein said wire wound core comprises a toroidal ring.

17. The inductor of claim 16 comprising an inner shell connected to a base and an outer shell connected to said base.

18. The inductor of claim 17 wherein said inner shell is positioned at least partially inside said toroidal ring.

19. An electrical inductor comprising:
at least one wire wound core;
at least one cavity adjacent to said at least one wire wound core;
a powder at least partially received within said at least one cavity;
an outer shell disposed outside said at least one wire core;
at least one inner shell disposed inside said at least one wire wound core;
wherein said inner shell is connected to said outer shell at a base;
wherein said at least one cavity is bounded in part by said outer shell and said at least one wire wound core; and
wherein said at least one cavity is bounded in part by said inner shell and said at least one wire wound core.
